(19) United States
(12) Patent Application Publication
(10) Pub. No.: US 2007/0081240 A1
(43) Pub. Date: Apr. 12, 2007

(54) Graphic representation and structure of physical inspection result

(76) Inventor: Cheng-Yang Lee, Tainan City (TW)

Correspondence Address: John S. Egbert;Egbert Law Offices, 7th Floor, 412 Main Street, Houston, TX, 77002, US

(21) Appl. No.: 11/245,973

(22) Filed: Oct. 11, 2005

(51) Int. Cl. G03B 21/56

(52) U.S. Cl. 359/443

(57) ABSTRACT

The graphic representation and structure of physical inspection results focuses on renovation of previous health reports primarily including words and numeral data of patient information. The human body system has a unique background of color or gray standard system diagram, while the complaints, physical examination, laboratory data and instrumental examination results of patients are prepared into a patient transparent film (drawing), which shall correspond to standard system diagram with respect to the human size. Then, the patient transparent film is superimposed into a standard system diagram, thereby offering an innovative graphic display of physical inspection report thanks to the transparency of films. And, the reporter may track and collect the medical history and records to prepare a clear and complete report optimally suited for bridging the gap between patients and physicians.

### RELATED U.S. APPLICATIONS

Not Applicable.

### STATEMENT REGARDING FEDERALLY SPONSORED RESEARCH OR DEVELOPMENT

Not Applicable.

### REFERENCE TO MICROFICHE APPENDIX

Not Applicable.

### FIELD OF THE INVENTION

The present invention relates generally to a graphic representation and structure of physical inspection results, and more particularly to modified ones with which the complaints and physical inspection results of patients are prepared into a patient system transparent film and placed into a standard physical inspection guide, thereby offering an innovative graphic display of physical inspection report.

### BACKGROUND OF THE INVENTION

Everyone in his life has to see a doctor for illness, pursuit examination, medical treatment, surgery or rehabilitation. As everybody knows, the hospitals usually maintain the medical records of patients into the records room, which are inaccessible to the patients. If the patients desire to access to the medical records, they have to submit for applications. However, it makes difficult for the new physicians to confirm the medical history if the patents have gone to doctors in several hospitals and could not offer a complete answer. Therefore, there is lack of a convenient bridge between the patients and physicians.

From the viewpoint of physicians, how to understand quickly the medical history and records is an important step to ensure the smooth medical consultation. Yet, many physicians now face a problem that they have to receive some new patients (e.g. old adults and mentally or physically retarded persons in terms of expression, vision/hearing and memory recession) incapable of explaining the medical history. In such case, the physicians and relevant staff have to do a time-consuming job. In addition, some medical examinations are performed once and again due to inefficient exchange between patients and physicians, leading to unnecessary resource waste.

Some individuals with routine inspection will submit their health reports to the physicians as a reference. However, these reports may differ a lot in the type, form and sequence as they are prepared from different hospitals or clinics. So, time-consuming work shall also be required for the physicians. It can thus be seen that there is not available an applicable tool to collect that health data.

Moreover, the insurance companies require for medical records of the insured prior to or at the beginning of covering insurance. If the insured have gone to doctors in many hospitals, a costly and time-consuming inquiry is required for the insurance company. Thus, if a complete and efficient health report can be provided for the benefit of the insured, it is possible to save time and cost for both the insured and insurers.

In sum, though everybody gains an easy access to various common health information from various sources in an information era, all data involving their own health state and medical history are maintained in the medical record rooms, which appear to make the patients lose the right of “know” their own health state. Furthermore, they have to be charged with such medical records. So, there is an urgent demand on medical records accessible to the patients at anytime. But, the patients cannot really exercise their rights to “understand the data” when they get their own medical records represented in a strange way.

Today, there is a long way to go for complete networking of nationwide medical records. To this end, the inventor has provided the present invention (i.e. Graphic Representation and Structure of Physical Inspection Results) after deliberate design and evaluation based on years of experience.

### BRIEF SUMMARY OF THE INVENTION

1. A graphic physical inspection report offers an improved report of patient information previously with only words and figures, thereby bridging the gap between the patients and physicians.

2. With the upsurge of Internet information and higher level of know-how, self-health management is becoming a prevailing trend today. The graphic representation of physical inspection results and health report offer you a correct approach to health. So, they facilitate to have a clearer understanding of the health state, and enable the physicians to make rapid and correct diagnosis. Moreover, it makes possible for the medical field to reduce unnecessary examination, save the health subsidies and avoid unwanted medical resource waste.

### BRIEF DESCRIPTION OF THE SEVERAL VIEWS OF THE DRAWINGS

FIG. 1 shows a perspective view of the first page and basic data sheet of health inspection report of the present invention.

FIG. 2 shows a perspective view of the full body photo of health inspection report.

FIG. 3 shows the exploded perspective view of the drawing of full body photo of health inspection report in FIG. 2.

FIG. 4 shows another exploded perspective view of the drawing of patient system diagram of health inspection report.

FIG. 5 shows the front elevation view of the combination chart of patient system diagram of health inspection report.

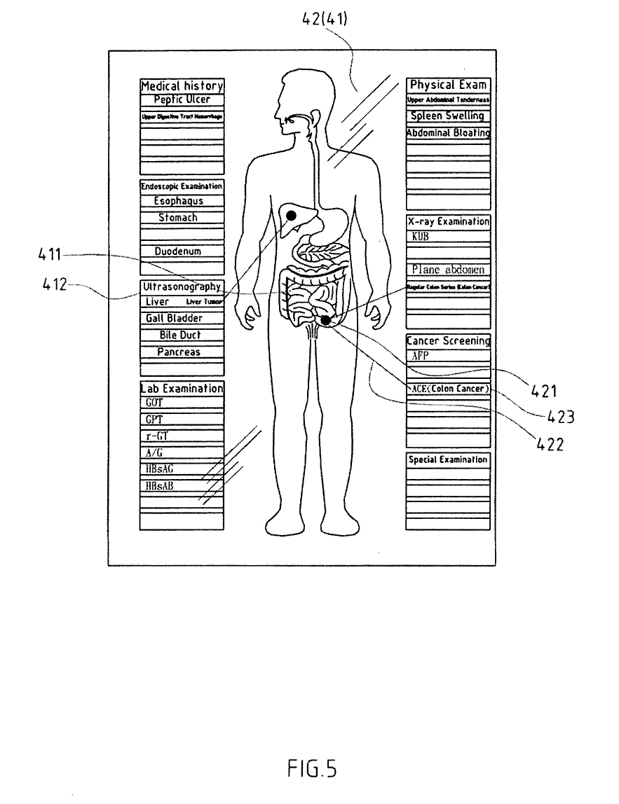

FIG. 6 shows another exploded perspective view of the combination chart of patient system diagram of health inspection report.

FIG. 7 shows the front elevation view of patient system diagram's transparent film overlaid onto standard system diagram versus marking status.

FIG. 8 shows a schematic view of the integration of the patient system's superimposed transparent films.

FIG. 9 shows a perspective view of the health inspection report with data collection bag.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

The graphic representation of physical inspection results in the present invention focuses on renovation of previous health reports primarily comprising only words and numeral data of patient information. Conversely, it turns to express physical state by means of pictures, sheets and curve diagrams. The major technological features of the present invention comprise:

a. Every physical system has a unique background of a color or gray standard system diagram. After being examined in hospitals, health inspection centers or inspection authorities, the results are prepared into a transparent film of patient system, which shall correspond to aforementioned standard system diagram. And, the inspection results of this patient system's transparent film are represented by: words, marks, pictures and specific characters (detailed below). The so-called “system” refers to ten physical systems, i.e. respiratory, circulatory, digestive, urinary, blood, nerves, skeleton, genital, endocrine and skin systems.

b. Next, the patient system's transparent film is overlaid onto the standard system diagram, such that it is possible to compare them thanks to transparency of such films. In the case of pictures, the comparable items comprise the size of profile, color, intensity and position, etc, whereby it is possible to find out the differences and problems in the patient system. Furthermore, the physical organs can provide a reference for comparing with a normal state. In the event of a size difference with a normal state (e.g. too big or small), for example hepatomegaly, the enlarged liver compare to the normal one, abnormality is detected. The abnormal state of physical system in medical imaging, for example X-ray or echo is often found out via the color and intensity of organs, such as tumor, solid mass and calculus; the different positions of organs compare with the normal one, such as floating kidney (the kidney fall into the pelvis cavity), are easy to judge.

c. When finding out any abnormality by comparing the patient system's transparent film with standard system diagram, the physicians or inspectors may directly mark it on the patient system's transparent film in many ways (e.g. words, or abbreviated drawings or specific signs). This will not only save the marking time, but also offer more aesthetically pleasing pictures and a higher consistency for convenient inquiry.

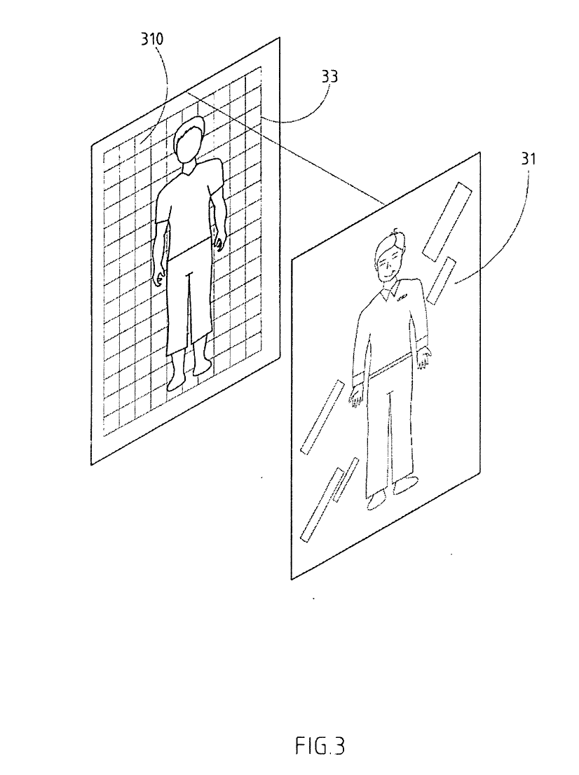

Of which, the standard system diagram comprises pigsty table lines for easy marking or sizing (with a reference to drawing no. 33 in FIG. 3), or customized fields, which correspond to words and characters in the patient system's transparent film.

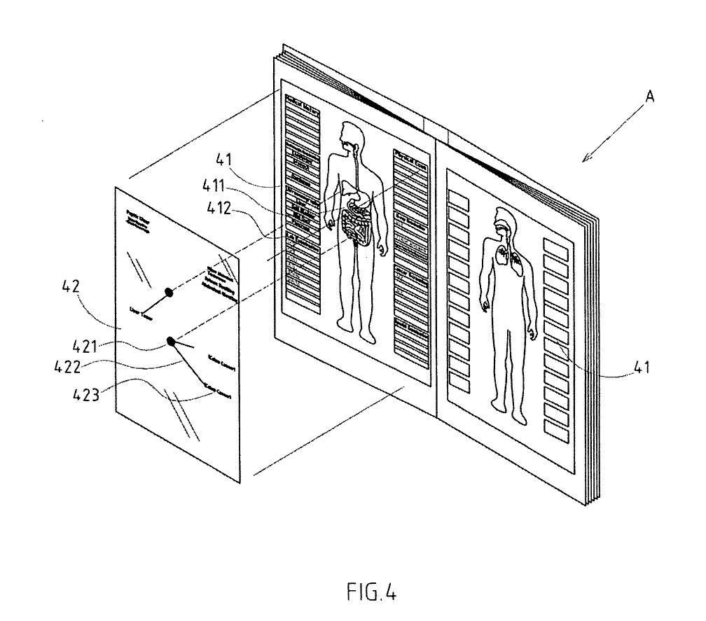

Of which, a preferred embodiment of the present invention is described here with respect to standard system diagram and patient system's transparent film. As illustrated in FIGS. 4, a physical system drawing 411 is built into the center of the standard system diagram 41 (a digestive system), while several customized fields 412 are placed at both sides. The fields comprise some inspection items, such as: endoscope survey, ultrasound survey, physical check and cancer screening, etc. So, the patient system's transparent film may be a transparent film 42, onto which the disease marking block 421, lead wire 422 and literal notation 423 of actual inspection results are presented. The positions of such inspection results correspond to physical system drawing 411 and customized fields 412 of aforesaid standard system diagram 41. As shown in the figure, the “carcinoma of large intestine” is rightly placed into the fields of “cancer screening” in the customized fields 412, while the disease marking block 421 corresponds to the position of large intestine in physical system drawing 411, thereby forming an intuitive “graphic” health report.

Of which, the standard system diagram has the same human body drawings such that the transparent films often patient systems can be overlaid (superimposed in computer) to form a graphic report involving system-wide inspection results.

Of which, the graphic representation of the present invention shall be practically documented (written health report), or prepared into video tapes or discs, or uploaded onto computer or TV screen via Internet.

When a health report of physical inspection results is prepared as per the graphic representation of the present invention, this health report A generally comprises the following parts.

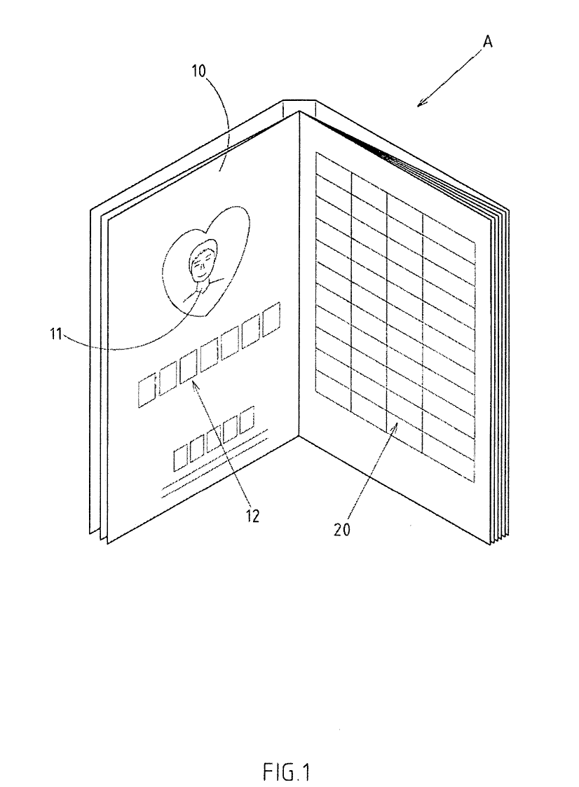

A first page 10 includes patient photos 11 (e.g. head portrait) and names 12, e.g. “health report of Hsiao-ming Wang”, as shown in FIG. 1.

A basic data report 20 includes date of birth, blood type, gender, age, telephone and hospitals.

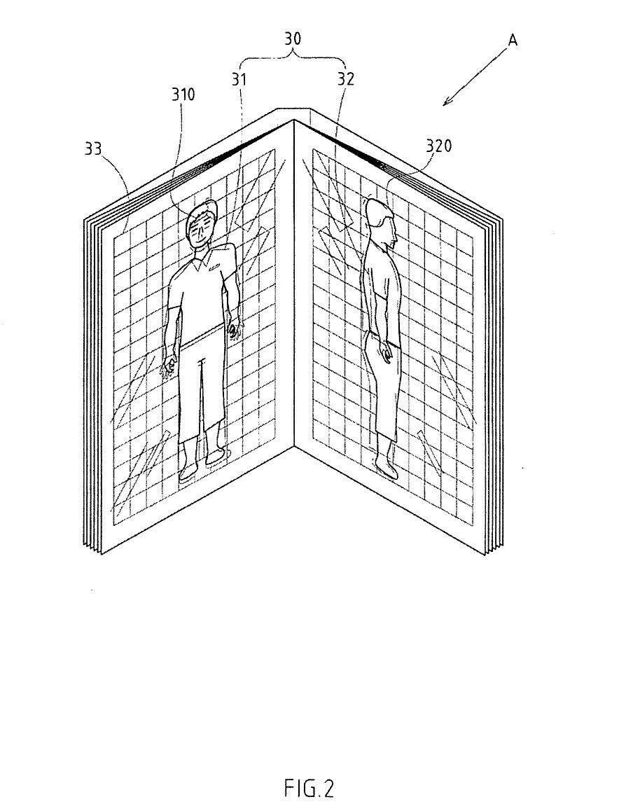

A patient's full body photo page 30 includes frontal photo 31 and lateral photo 32. As the patient system's transparent films are overlaid onto the standard system diagram, as shown in FIGS. 2, 3, the frontal photo 31 and lateral photo 32 are prepared into transparent films and separately superimposed onto a frontal photo chart 310 and a lateral photo normal chart 320. In order to clearly identify the difference of profiles between patients and healthy individuals, and understand the tolerance of weight and stature. Moreover, a frontal photo chart 310 and a lateral photo chart 320 comprise pigsty table line 33 for marking and sizing; the full body photo is also available with another structure, namely, shooting a patient photo with grid lines, whereby the patient's physical size is displayed.

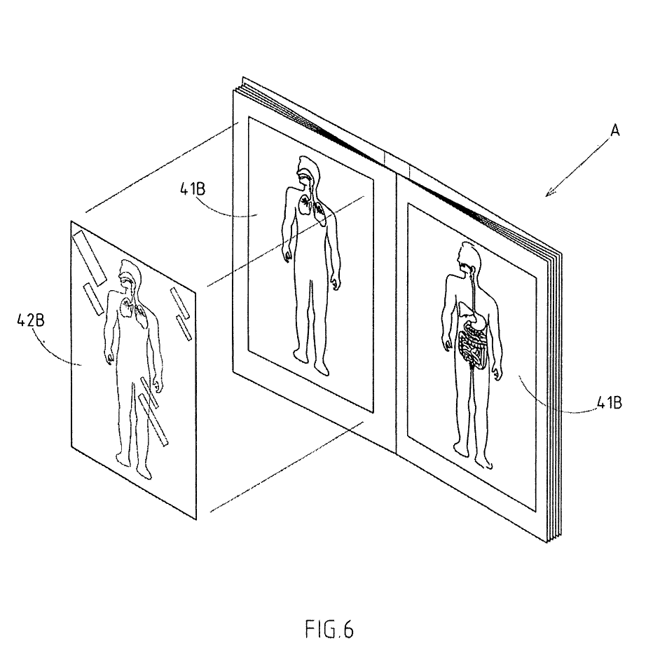

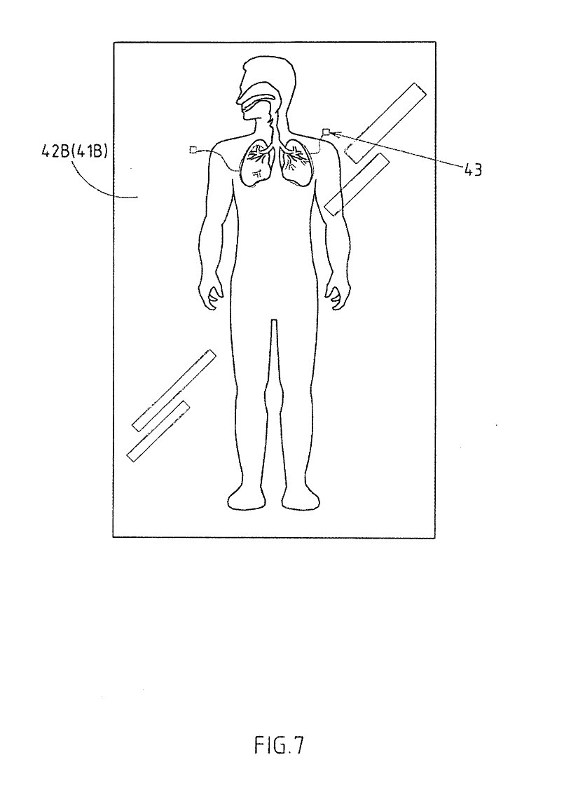

The patient system's graphic inspection report is illustrated in FIGS. 6, 7, wherein the inspection results are obtained by superimposing a standard system diagram 41B onto a patient system's transparent film 42B. Of which, the standard system diagram 41 B enables the human body system to be displayed by color or gray charts. The patient system's transparent film 42B is transparent X-ray film or photo taken by the hospitals or inspection agencies, and corresponds to aforesaid standard system diagram; the human body system presented by patient system transparent film 42B and standard system diagram 41 B has a consistent size. As shown in FIG. 7, the standard system diagram 41B and patient system's transparent film 42B are schematic drawings involving inspection results of respiratory system. Of which, the different signs 43 between human body system and standard system are marked onto the patient system's transparent film 42B.

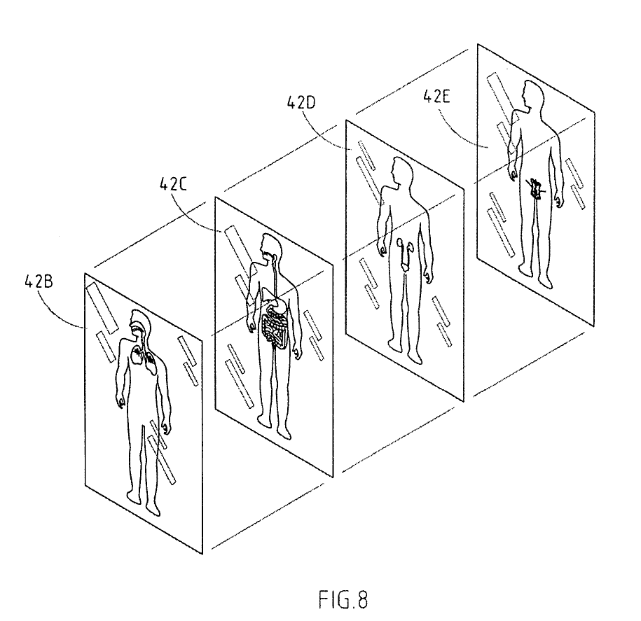

The patient system's integrated graphic inspection report is a graphic report superimposed by patient system's transparent film 42B covering various human body systems (e.g. respiratory, circulatory, digestive, urinary, blood, nerve, skeleton, genital, endocrine and skin systems, or local systems). This helps to form an integrated inspection report for the benefit of patients; as shown in FIG. 8, four patient system transparent films 42B, 42C, 42D and 42E are represented separately by respiratory, digestive, urinary and genital system, which permit to prepare an integrated graphic report by superimposing transparent films.

The integrated system disease report is used to present the symptoms of full body system, which are listed sequentially and marked with highlighted blocks; the data source fields are available from highlighted oral statement of patients, or inspection results of other hospitals, or different inspection results from the same hospital.

The patients' health and disease database comprises their medical history, surgical operation history, family medical history, dosage history of chronic diseases, drug allergy and X-ray films.

Of which, the aforesaid health inspection report A comprises guidelines to future health management for patients (as disclosed in Annex 4 for guideline to inspection of digestive system).

Of which, the written health inspection report A shall be preferably documented by loose-leaf. All data can then be updated and replaced, unlike conventional health examination that requires all works to be done in one time. In such case, there will be a room for future report or health examination when the patients are scared to accept invasive examination, for example panendoscopy and colonscopy. Alternatively, data entry is made possible when the patients are well prepared in this respect

All data associated with health inspection and medical record (e.g. health inspection report of hospitals and health center, admission note, PAP smear, prescription of chronic disease, discharge summary and transfer certificate) can be entered into the health inspection report, with the remaining parts supplemented by the patients at their discretion. The medical inspection results are divided into necessary and recommended ones, which are arranged sequentially, or used to guide the patients step-by-step to know when and what is required for inspection and health management.

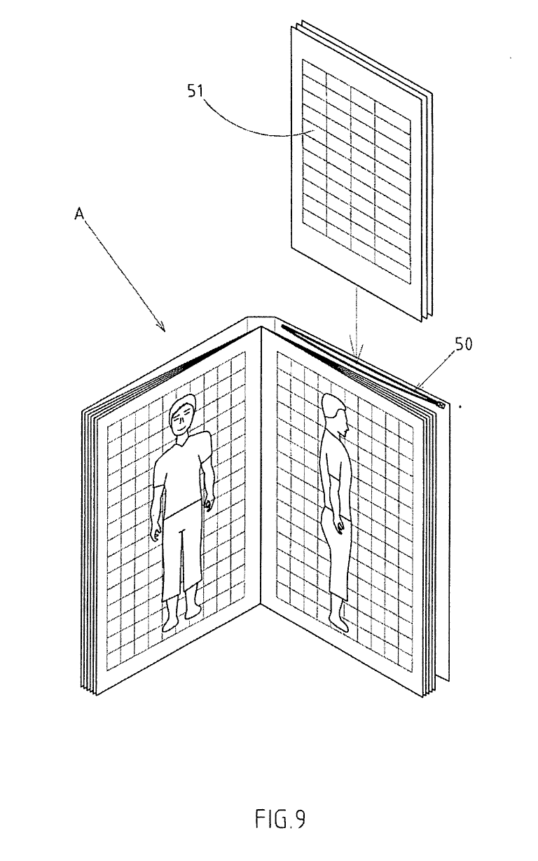

The health inspection reports are fed back and updated in the hospitals (or various health inspection report production centers) semi-annually or annually. This report A is supplemented with data collection bag 50 (as shown in FIG. 9), into which all data of patients 51 shall be entered. At the same time, the health inspection report production center will list them into the health report (or disc).

Of which, the health inspection report A is classified below according to the gender and age group:
1) Health certificate for male infant (0-2 years old): focusing on growth and development.
2) Health certificate for female infant (0-2 years old): focusing on growth and development.
3) Health certificate for boy (2-15 years old): focusing on growth and development.
4) Health certificate for girl (2-15 years old): focusing on growth and development, menarche.
5) Health certificate for male youth (15-40 years old): cancer screening, prevention of adult diseases.
6) Health certificate for female youth (15-40 years old): cancer screening, prevention of adult diseases, cervix film and supersonic breast survey.
7) Health certificate for old adults (over 40 years old): focusing on tracking of old adults' diseases and health management.

I claim:

1. A method graphic representation of physical inspection results comprising the steps of:
creating every physical system having a unique background of a color or gray standard system diagram, after being examined in hospitals, health inspection centers or inspection authorities, results being prepared into a transparent film of patient systems, corresponding to the standard system diagram; and
overlaying a transparent film of the patient system onto the standard system diagram, comparing by transparency of the films, and identifying differences and problems in the patient system.

2. The method defined in claim 1, wherein a physical system is comprised of human body system being comprised of respiratory, circulatory, digestive, urinary, blood, nerve, skeleton, genital, endocrine and skin systems.

3. The method defined in claim 1, further comprising:
superimposing the transparent film of every patient system to form a graphic report of full body inspection report.

4. The method defined in claim 1, further comprising:
practically documenting the graphic representation of physical inspection results;
preparing the graphic representation of physical inspection results into video tapes or discs; or
uploading the graphic representation of physical inspection results onto computer or TV screen via Internet.

5. A method of graphic presentation of physical inspection results, comprising the steps of:
creating a standard system diagram serving as a background represented by color or gray scale chart of a human body system;
preparing a transparent film of a patient system by inspection results of hospitals, health inspection centers or agencies, corresponding to a standard system diagram; and
overlaying the transparent film of the patient system onto the standard system diagram to compare films by transparency of the films, and identifying differences and problems in the patient system.

6. The method defined in claim 5, wherein said human body system is comprised of respiratory, circulatory, digestive, urinary, blood, nerve, skeleton, genital, endocrine and skin systems.

7. The method defined in claim 5, further comprising:
representing inspection results of the transparent film of the patient system by words, marks, pictures and specific characters.

8. The method defined in claim 5, wherein said standard system diagram comprises table lines or customized fields.

9. The method defined in claim 5, further comprising:
superimposing the transparent film of said patient system to form a graphic report of full body system inspection results.

10. The method defined in claim 5, further comprising:
documenting the standard system diagram and the transparent film of the patient system;
preparing the standard system diagram and the transparent film of the patient system into video tapes or discs; or
uploading the standard system diagram and the transparent film of the patient system onto computer or TV screen via Internet.

11. A health inspection report comprising:
a first page being comprised of patient photos and names;
a basic data report being comprised of birthday, blood type, gender, age, telephone and hospitals;
a full body photo page of a patient, being comprised of a frontal photo and lateral photo of patients;
a graphic inspection report of a patient system, with the inspection results obtained by superimposing a standard system diagram onto a transparent film of a patient system; a standard system diagram enabling a human body system to be displayed by color or gray charts; the transparent film of the patient system being a transparent X-ray film taken by the hospitals or inspection health centers or agencies, and corresponding to said standard system diagram;
an integrated graphic inspection report of the patient system, being a graphic report superimposed by the transparent film of the patient system covering various human body systems, forming an integrated inspection report for the benefit of patients;
an integrated system disease report, used to present symptoms of a full body system; and
a health and disease database of patients, being comprised of medical history, surgical operation history, family medical history, dosage history of chronic diseases, drug allergy and X-ray films.

12. The report defined in claim 11, wherein inspection results of said patient system's transparent film are presented by: words, marks, pictures and specific characters.

13. The report defined in claim 11, wherein said standard system diagram has table lines or customized fields.

14. The report defined in claim 11, wherein said health inspection report has guidelines to future health management for patients.

15. The report defined in claim 11, wherein each report is documented, prepared into video tapes or discs, or uploaded onto computer or TV screen via Internet.

16. The report defined in claim 11, wherein the frontal photo and lateral photo are prepared into transparent films and separately superimposed onto a frontal photo chart and a lateral photo normal chart, thereby showing the difference of profiles between patients and healthy individuals.

17. The report defined in claim 11, wherein said frontal photo and lateral photo each have charts for table lines or customized fields being available for marking and sizing and corresponding to the transparent film of the patient system.
